(19) United States
(12) Patent Application Publication
(10) Pub. No.: US 2009/0103900 A1
(43) Pub. Date: Apr. 23, 2009

(54) Acquiring high definition content through visual capture and re-compression

(75) Inventor: Brant Candelore, San Diego, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Sony Electronics Inc.

(21) Appl. No.: 11/975,272

(22) Filed: Oct. 17, 2007

(51) Int. Cl. H04N 5/91; H04N 5/00; H04N 7/26

(52) U.S. Cl. 386/123; 386/118; 386/109; 386/E05.007; 386/E05.003

(57) ABSTRACT

An embodiment of the present invention includes a technique to visually capture a high definition (HD) content. A supplementary display device displays the HD content being transmitted to a primary display device. An image sensor captures the HD content displayed on the supplementary display device.

### BACKGROUND

1. Field of the Invention

Embodiments of the invention relate to the field of video technology, and more specifically, to visual capture.

2. Description of Related Art

High Definition (HD) content such as HD television (HDTV) has become increasingly popular. The development of HD technology has created many challenges in consumers market including display devices, set-top boxes (STBs), receiver subsystems, transmission technology, etc. One problem is that HD content may not be available without rendering the service provider's user interface (UI) such as OpenCable Application Platform (OCAP) or Media Center Extender, and Digital Rights Management (DRM) system for protecting content.

The fair use doctrine allows copying copyrighted materials under some guidelines. However, these guidelines may be revised with the advent of HD security protocols such as High-Bandwidth Digital Content Protection (HDCP) and Digital Transmission Content Protection (DTCP). Currently, there is no existing simple solution to provide legitimate transmission or copying of HD content without dealing with the complexities of the service provider's UI.

### BRIEF DESCRIPTION OF THE DRAWINGS

Embodiments of the invention may best be understood by referring to the following description and accompanying drawings that are used to illustrate embodiments of the invention. In the drawings:

FIG. 1 is a diagram illustrating a system according to one embodiment of the invention.

FIG. 2 is a diagram illustrating a visual capture unit according to one embodiment of the invention.

FIG. 3 is a diagram illustrating a processing unit according to one embodiment of the invention.

FIG. 4 is a flowchart illustrating a process to visually capture HD content according to one embodiment of the invention.

FIG. 5 is a flowchart illustrating a process to process captured HP content according to one embodiment of the invention.

FIG. 6 is a diagram illustrating a computer system to implement the processing unit according to one embodiment of the invention.

### DESCRIPTION

An embodiment of the present invention includes a technique to visually capture a high definition (HD) content. A supplementary display device displays the HD content being transmitted to a primary display device. An image sensor captures the HD content displayed on the supplementary display device.

In the following description, numerous specific details are set forth. However, it is understood that embodiments of the invention may be practiced without these specific details. In other instances, well-known circuits, structures, and techniques have not been shown in order not to obscure the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

Embodiments of the invention include a technique to acquire or capture a HD content visually, i.e., the rendered HD content as seen on a display screen, and re-compress the acquired or captured content for transmission. A supplementary display device (SDD) displays the HD content being transmitted to a primary display device. An image sensor positioned at a pre-determined location in front of the SDD to capture the HD content being displayed on the SDD. The pre-determined location corresponds to an optimal capture mode. The visual capture is free of distortion or artifacts caused by the glass optics typically associated with a display device. In addition, it does not require adjustment of lighting condition or other set-up requirements. A processing unit processes the captured HD content to re-compress the captured HD content according to a compression standard such as a Moving Picture Experts Group (MPEG) standard including MPEG-2 and advanced video coding (AVC). The re-compressed HD content may be transmitted to a remote device through a network (e.g., a home network) or recorded and stored in a storage unit.

The visual capture of the HD content provides a number of benefits. The complete unit may be optimally packaged for small size, minimum housing, minimum lens construction, and integrated functionality, resulting in low cost and high reliability. In addition, the capture is accurate and clean because there is no optical artifacts (e.g., glare, out of focus, distortion). The compressed HD content may be streamed to be sent over a network such as a home network. The content may be copy protected for use in a personal environment such as a home network.

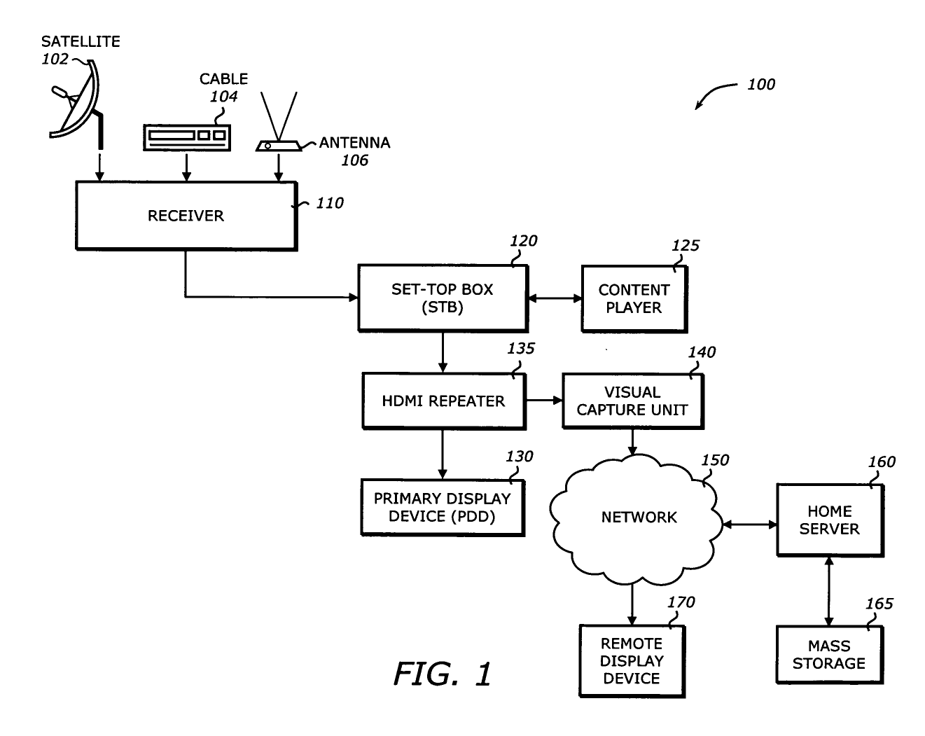

FIG. 1 is a diagram illustrating a system 100 according to one embodiment of the invention. The system 100 includes a receiver 110, a set-top box (STB) 120, a primary display device (PDD) 130, a visual capture unit 140, a network 150, a home server 160, and a remote display device 170. Note that the system 100 may contain more or less than the over components. For example, the home server 160 may not be present.

The receiver 110 receives the HD content transmitted from a number of content sources. The receiver 110 may include a radio frequency (RF) receiver or any other front-end processing component (e.g., switcher). The RF processing component may be integrated within the STB 120. The content source may be a satellite source 102, a cable source 104, or an over-the-air (OTA) terrestrial broadcast source received by antenna 106. The HD content source may be a broadcast program network, a cable operator, a video-on-demand (VOD) multiple system/service operator (MSO), a content distributor, or any content provider or system/service operator that provides, delivers, or distributes the content materials to a number of content subscribers. The OTA HD content may be transmitted as an HD signal using a modulation scheme according to a suitable HD specification or standard such as the 8-level Vestigial Sideband (8VSB) modulation by the Advanced Television Systems Committee (ATSC) standard or Digital Video Broadcasting (DVB) standards as published by the Joint Technical Committee (JTC) of European Telecommunications Standards Institute (ETSI), European Committee for Electro-technical Standardization, and European Broadcasting Union (EBU).

The HD content may be any content that is formatted in HD such as films, movies, broadcast features, documentary films, television programs, special shows, show episodes, etc. The typical HD format is defined by the ATSC as wide screen 16:9 images of up to 1920×1080 pixels in size.

The STB 120 or set-top unit (STU) is a device that receives the HD signal containing the HD content, decodes the digital television broadcast signals, and interfaces to the PDD 130. The STB 120 may have RF circuitry to process the received signal, demodulate, decode, tune, and perform necessary tasks to extract the HD content to be transmitted to the PDD 130. The STB 120 may include a digital video recorder to record the received HD content. The STB 120 may also have interface to a content player 125 such as a DVD player to transmit to the PDD 130.

The STB 120 may be operated by a service provider. It may not have a compressed digital interface, such as the Institute of Electrical and Electronics Engineers (IEEE) 1394 or IP, to record content or distribute content. Both those interfaces can use Digital Transmission Copy Protection (DTCP) to secure content on a home network. If the STB 120 has those interfaces, the service provider may have specialized user interface (UI) that renders the operator “look and feel” on remote devices. The service operator may accomplish this through the use of JAVA, such as with the OCAP cable initiative or the ATSC Common Application Platform (ACAP) ATSC initiative, or the Media Center Extender Microsoft initiative.

The PDD 130 may be any suitable display device that is used to primarily display the HD content transmitted by the STB 120. It may not necessarily actually display the HD content from the STB 120. It may be a high resolution flat panel display, a TV display, a computer display monitor, or any other display device suitable for HD display. The PDD 130 may have appropriate connectors and/or interface to receive the HD content as provided by the STB 120 such as Digital Video Interface (DVI) or High Definition Multimedia Interface (HDMI). Both those uncompressed content interfaces use HDCP to protect content. Those interfaces are usually point-to-point. In order to drive multiple displays, a DVI or HDMI repeater 135 may be used. In one embodiment of the invention, an HDMI repeater 135 may be used. It should be noted that any other devices with similar functionalities as the HDMI repeater 135 may be used instead.

The HDMI repeater 135 is connected to the STB 120. One port of the HDMI repeater 135 is connected to the PDD 130. A second port of the HDMI repeater 135 is connected to the visual capture unit 140. The visual capture unit 140 is connected to the HDMI repeater 135 to visually capture the HD content that is also being transmitted to the PDD 130. It should be noted that the HDMI repeater 135 may be built into the visual capture unit 140. As with the PDD 130, the visual capture unit 140 may have appropriate connectors or interface such as DVI or HDMI to receive the stream containing the HD content. The visual capture unit 140 may re-compress the captured HD content and transmit it to the network 150. The visual capture unit 140 provides a means to capture and recompress HD content when no compressed digital interface, e.g. IEEE 134 or IP, exists. Even if an interface did exist, the visual capture unit 140 does so without going through the UI requirements, rendering a particular “look and fee”, from the service providers. Since the visual capture unit 140 captures the HD content at the visual level, i.e., when the HD content is being displayed, it behaves like a legitimate TV as the PDD 130. It is not a circumvention device that may be prohibited by DRM technologies or other copy protection protocols such as the HDCP or DTCP. The licensing rules for display interfaces using HDMI or DVI use HDCP which is not violated because it is not modified, broken, or otherwise “hacked”.

The visual capture unit 140 may be packaged in a special housing or package that can be attached to the PDD 130 or the STB 120. As mentioned earlier, it may include an HDMI repeater 135. The special housing provides an optimal lighting condition for capturing the visual content being displayed.

The network 150 is any network that is used to transmit the re-compressed HD content as sent by the visual capture unit 140 to other devices such as the home server 160 and the remote display device 170. The network 150 may include at least one of an Internet Protocol (IP) network, a wireless local area network (LAN), and a power line communication (PLC). In one embodiment, the network 150 is a home network used in a home environment. In this environment, the use of the HD content may be appropriately classified as a private use.

The home server 160 may be any server suitable for home or private use. It may have features such as media streaming, remote administration, file sharing, centralized backup, etc. It may run a home server operating system. It may have connection to any appropriate mass storage device such as a mass storage 165. The mass storage 165 may store the HD content as captured by the visual capture unit 140. The remote display device 170 may be a display device that is located at a location other than the PDD 130, such as in another room in a home.

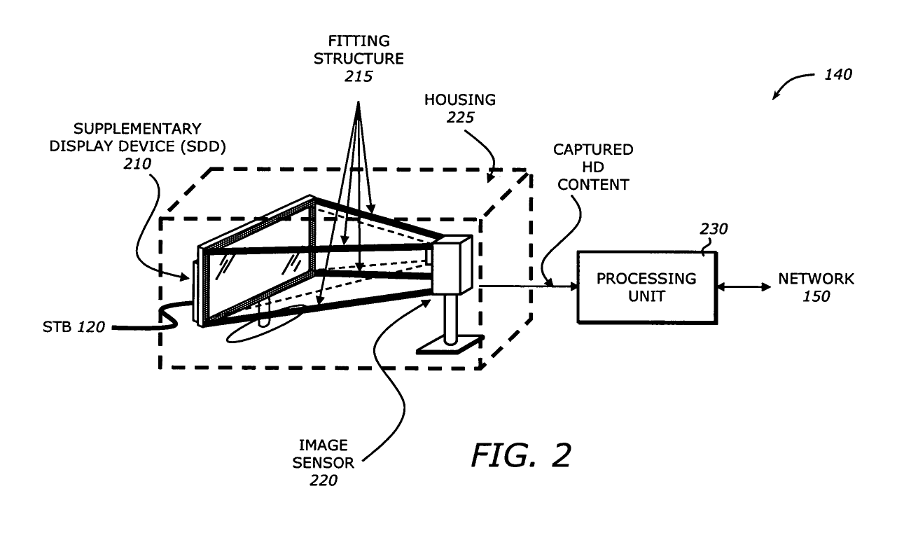

FIG. 2 is a diagram illustrating the visual capture unit 140 shown in FIG. 1 according to one embodiment of the invention. The visual capture unit 140 includes a supplementary display device (SDD) 210, an image sensor 220, a housing 225, and a processing unit 230. The visual capture unit 140 may include more or less than the above components. For example, the processing unit 230 may be incorporated in the image sensor 220 or vice versa.

The SDD 210 displays the HD content being transmitted to the PDD 130. It may be any display device that is capable of displaying HD content. It typically has HD connection interface such as DVI or HDMI. It may be one of a liquid crystal display (LCD) device, an electronic paper, an organic light-emitting-diode (OLED) device, and interferometric modulator display (IMOD) device. Typically, the SDD 210 may be a mini-television (TV) that shows essentially the same information as shown on the PDD 130, except that its size is a lot smaller and more compact. It may support the full HD resolution or a sub-optimal mode which displays less than the HD resolution. It may have high dynamic contrast ratio (e.g., up to 3000:1). Unlike typical display devices that are designed for direct human viewing, the SDD 210 may be designed mainly for direct visual capture. Accordingly, it does not need to have features such as protection glass, wide viewing angle range, or any other optical components that are used to enhance human viewing.

The image sensor 220 captures the HD content displayed on the SDD 210. The image sensor 220 is placed at a position that has been selected to provide the optimal capturing. The image sensor 220 may have lens having a focal length that is best matched with the distance between the image sensor 220 and the SDD 210 that corresponds to the optimal capturing. It may be a charge coupled device (CCD) sensor or a complementary metal oxide semiconductor device (CMOS) sensor. It may incorporate electronic circuitry for obtaining digital data representing the color pixels on the display surface of the SDD 210. The image sensor 220 is capable of capturing HD content at the full or sub-optimal HD resolution. Sub-optimal HD resolutions are resolutions that are less than 1920×1080. In some instances, sub-optimal HD resolution may be desired for HD content.

The SDD 210 and the image sensor 220 may be attached to each other or integrated together using a fitting structure 215. The fitting structure 215 may be a structure that is separate from the SDD 210 and the image sensor 220 and attached to both the SDD 210 and the image sensor 220 via attaching mechanisms at both devices. It may be integrated with the SDD 210 and attached to the image sensor 220 via an attaching mechanism. Alternatively, it may be integrated with the image sensor 220 and attached to the SDD 210 via an attaching mechanism. It may also be integrated with both the SDD 210 and the image sensor 220 as a single unit. The fitting structure 215 may be designed to provide a desired coupling (e.g., proper distance or position) between the SDD 210 and the image sensor 220 such that the capture of the image may be optimal (e.g., in terms of capture angle, lighting, or focus, or any combination of them). In addition, the fitting structure 215 may also be adjustable to accommodate various positions or placements of the image sensor 220 with respect to the SDD 210 to achieve the desired image capturing.

The housing 225 houses or encloses the SDD 210, the image sensor 220, and the fitting structure 215 to provide proper lighting condition for the image capture. Accessories may be attached to the housing such as batteries, battery holder, or lighting components. The housing 225 may also have an adjustable opening mechanism to adjust the amount of ambient light entering the inside of the housing. The opening mechanism may be adjusted to prevent the ambient light from striking on the display surface of the SDD 210 that may cause undesirable reflection or other optical artifacts that may degrade the image capturing process.

The processing unit 230 processes the captured HD content as provided by the image sensor 220. The processing unit 230 may incorporate the image sensor 220. It has interface to the network 150 to transmit the captured HD content.

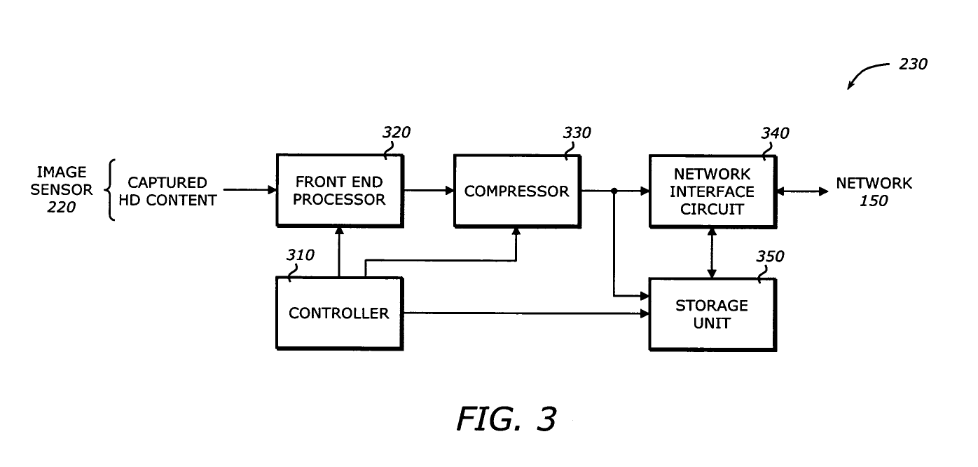

FIG. 3 is a diagram illustrating the processing unit 230 shown in FIG. 2 according to one embodiment of the invention. The processing unit 230 includes a controller 310, a front-end processor 320, a compressor 330, a network interface circuit 340, and a storage unit 350. The processing unit 230 may include more or less than the above components. The processing unit 230 may be implemented by hardware, software, firmware, or a combination of any of them.

The controller 310 controls the operation of the front-end processor 320, the compressor 330, the network interface circuit 340, and the storage unit 350. It may be a general-purpose microprocessor, a special purpose applications specific integrated circuit (ASIC), a digital signal processor (DSP), a specialized control circuit, or any other circuit that may provide control functionalities. It may generate appropriate timing signals to sample the front-end processor 320 to acquire the digital data representing the pixels from the HD content. The controller 310 may also perform other tasks such as detection of any copy control information embedded in the HD content stream to determine if copying is allowed, detection of watermarking, reconstruction of a watermarked content, responding to the watermark copy protection information, such as to change “copy-once” to a “copy-no-more” designation, etc.

The front-end processor 320 performs front-end tasks such as input/output (I/O) functions, video processing, and audio processing tasks. The I/O functions may include digital interfaces to DVI or HDMI. The video processing tasks may include level/color/hue/clip controls, noise reduction, frame synchronization, analog-to-digital. conversion (ADC), up/down conversion with aspect ratio conversion, etc. The audio processing tasks may include level/invert/delay/swap controls, analog-to-digital conversion, decompression, sample rate conversion, synchronization and timing to video, etc. In one embodiment, the video ADC may be included as part of the image sensor 220.

The compressor 330 compresses the captured HD content to a compressed content according to a compression standard. The compressed content may be copy protected. The compression standard may be a Moving Picture Experts Group (MPEG) standard such as MPEG-2 and MPEG-4, referred to as advanced video coding (AVC). The compression may support up to 4:2:2 YCbCr chroma sub-sampling with 10-bit quantization, or 4:2:0 YCbCr with 8-bit quantization. Alternatively, the compression may meet any compression requirements as required by the subsequent display or storage. The compressor 330 may have a bypass mode to allow the uncompressed captured HD content to pass through for transmission or storage if desired.

The network interface circuit 340 transmits the compressed content to the network 150. The network interface circuit 340 is compatible with any network protocol as required by the network 150. This may include IP network, wireless LAN, and PLC network.

The storage unit 350 stores the captured HD content or the compressed content. The storage unit 350 may be any suitable storage device. It may include Small Computer System Interface (SCSI), serial SCSI, Advanced Technology Attachment (ATA) (parallel and/or serial), Integrated Drive Electronics (IDE), enhanced IDE, ATA Packet Interface (ATAPI), etc. The storage device 350 may include high-capacity high speed storage arrays, such as Redundant Array of Inexpensive Disks (RAIDs), Network Attached Storage (NAS), digital tapes, or any other magnetic or optic storage devices.

If the processing unit 230 only captures the visual HD content, re-compresses, and transmits it through the network 150, no permanent copy of the HD content has been made. When the captured HD content is stored, then a copy may be made. In many scenarios, the home user has the right to “fair use” of the content. What exactly “fair use” is may be a matter of contention. The content may be recorded in-the-clear. The content owners generally want technological means to block free copying of recorded copy protected content. But this does not necessarily need to take place. HDMI does not send any CCI data because it has 2 states—“copy free” and “no copying”. The “copy free” state is merely a transmission state without HDCP. It was not designed to be a copying interface. It cannot distinguish between content that is “copy once” and “copy free”. Some proposed copy protection schemes use watermarking. These can embedded CCI information in the rendered content. In this case, the processing unit 230 can respond to the watermarking information to change “copy-once” to a “copy-no-more” designation which can be stored along with the content. For copy-free HD content, the processing unit 230 is free to store the captured HD content without concern. For copy-never content, the processing unit 230 may not allow storing the captured HD content. In one embodiment of the invention, the visual capture unit 140 may respond to watermarking. It is possible that the visual capture unit 140 may record content without regard to CCI based on the “fair use” doctrine. Or that it may output all content “copy never” so that it may not be recordable—only streamed to other locations in the home.

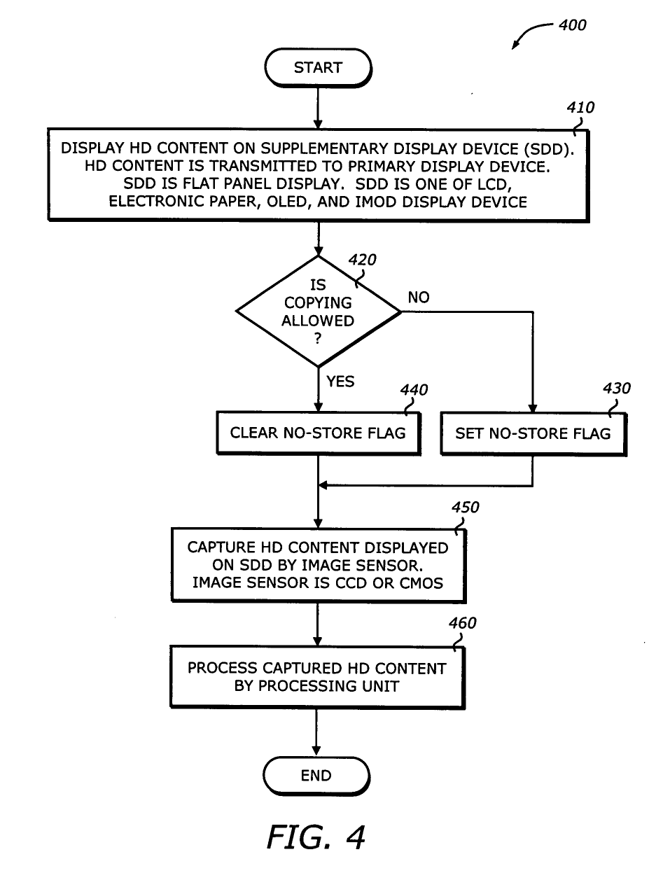

FIG. 4 is a flowchart illustrating a process 400 to visually capture HD content according to one embodiment of the invention.

Upon START, the process 400 displays a HD content on a supplementary display device (Block 410). The HD content is transmitted to a primary display device. But it is not absolutely necessary to render content on the primary display device, for example, if content were to be viewed in an adjoining room, e.g. bedroom. The SDD is a compact display device acting as a mini TV display. It may be a flat panel display and one of a LCD device, an electronic paper, an OLED device, and IMOD device.

Next, the process 200 determines if copy is allowed (Block 420). This may be performed by detecting and/or checking the copy control information (CCI) embedded in the HD content stream (e.g., watermark). If copying is not allowed, such as when the CCI indicates that the HD content is copy-never or copy-no-more, the process 200 sets a no-store flag (Block 430) and then proceeds to Block 450. A no-store flag is a flag, when set, that indicates that the content cannot be stored. A copy-never or copy-no-more HD content may still be streamed or transmitted as long as a permanent copy is not made. If copying is allowed, such as when the CCI indicates that the content is “copy-free” or “copy-once”, the process 200 clears the no-store flag (Block 440). Then, the process 200 captures the HD content displayed on the supplementary display device by an image sensor (Block 450). Then, the process 200 processes the captured HD content by a processing unit (Block 460) and is then terminated.

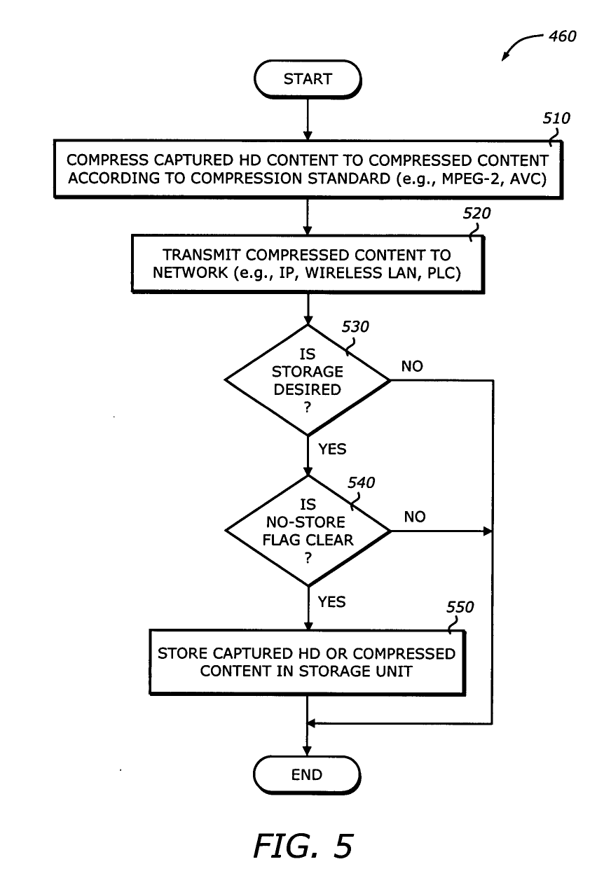

FIG. 5 is a flowchart illustrating the process 460 shown in FIG. 4 to process captured HP content according to one embodiment of the invention.

Upon START, the process 460 compresses the captured HD content to a compressed content according to a compression standard (Block 510). The compression standard may be MPEG-2 or AVC. Next, the process 460 transmits the compressed content to a network (Block 520). The network is typically a home network for private use.

Then, the process 460 determines if storage is desired (Block 530). If not, the process 460 is terminated. Otherwise, the process 460 determines if the no-store flag is clear (Block 540). If not, the process 460 is terminated. Otherwise, the process 460 stores the captured HD content or the compressed content in a storage unit (Block 550) and is then terminated.

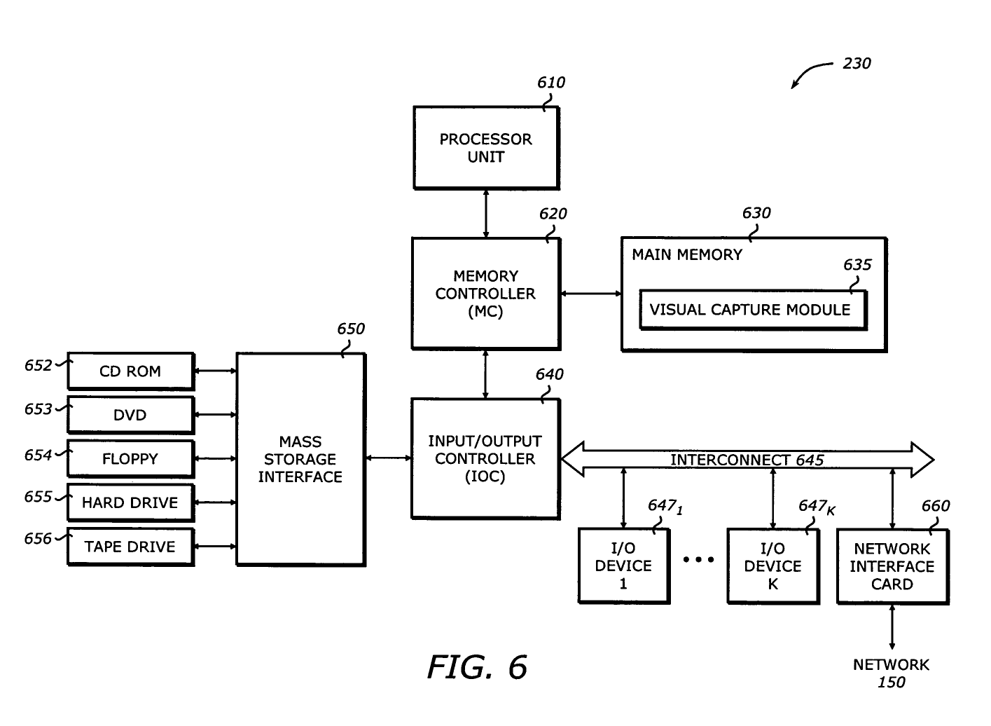

FIG. 6 is a diagram illustrating a computer system to implement the processing unit 230 shown in FIG. 2 according to one embodiment of the invention. The processing unit 230 includes a processor 610, a memory controller (MC) 620, a main memory 630, an input/output controller (IOC) 640, an interconnect 645, a mass storage interface 650, input/output (I/O) devices 647₁ to 647_{K}, and a network interface card (NIC) 660. The processing unit 230 may include more or less of the above components.

The processor 610 represents a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The MC 620 provides control and configuration of memory and input/output devices such as the main memory 630 and the IOC 640. The MC 620 may be integrated into a chipset that integrates multiple functionalities such as graphics, media, isolated execution mode, host-to-peripheral bus interface, memory control, power management, etc. The MC 620 or the memory controller functionality in the MC 620 may be integrated in the processor unit 610. In some embodiments, the memory controller, either internal or external to the processor unit 610, may work for all cores or processors in the processor unit 610. In other embodiments, it may include different portions that may work separately for different cores or processors in the processor unit 610.

The main memory 630 stores system code and data. The main memory 630 is typically implemented with dynamic random access memory (DRAM), static random access memory (SRAM), or any other types of memories including those that do not need to be refreshed. The main memory 630 may include multiple channels of memory devices such as DRAMs. The DRAMs may include Double Data Rate (DDR2) devices with a bandwidth of 8.5 Gigabyte per second (GB/s). In one embodiment, the memory 630 may include a visual capture module 635 which may implement all or parts of the functionalities of the controller 310, the front-end processor 320, the compressor 330, the network interface circuit 340, and the storage unit 350 shown in FIG. 3.

The IOC 640 has a number of functionalities that are designed to support I/O functions. The IOC 640 may also be integrated into a chipset together or separate from the MC 620 to perform I/O functions. The IOC 640 may include a number of interface and I/O functions such as peripheral component interconnect (PCI) bus interface, processor interface, interrupt controller, direct memory access (DMA) controller, power management logic, timer, system management bus (SMBus), universal serial bus (USB) interface, mass storage interface, low pin count (LPC) interface, wireless interconnect, direct media interface (DMI), etc.

The interconnect 645 provides interface to peripheral devices. The interconnect 645 may be point-to-point or connected to multiple devices. For clarity, not all interconnects are shown. It is contemplated that the interconnect 645 may include any interconnect or bus such as Peripheral Component Interconnect (PCI), PCI Express, Universal Serial Bus (USB), Small Computer System Interface (SCSI), serial SCSI, and Direct Media Interface (DMI), etc.

The mass storage interface 650 interfaces to mass storage devices to store archive information such as code, programs, files, data, and applications. The mass storage interface may include SCSI, serial SCSI, Advanced Technology Attachment (ATA) (parallel and/or serial), Integrated Drive Electronics (IDE), enhanced IDE, ATA Packet Interface (ATAPI), etc. The mass storage device may include high-capacity high speed storage arrays, such as Redundant Array of Inexpensive Disks (RAIDs), Network Attached Storage (NAS), digital tapes, optical storage, etc.

The mass storage device may include compact disk (CD) read-only memory (ROM) 652, digital video/versatile disc (DVD) 653, floppy drive 654, hard drive 655, tape drive 656, and any other magnetic or optic storage devices. The mass storage device provides a mechanism to read machine-accessible media.

The I/O devices 647₁ to 647_{K} may include any I/O devices to perform I/O functions. Examples of I/O devices 647₁ to 647_{K} include controller for input devices (e.g., keyboard, mouse, trackball, pointing device), media card (e.g., audio, video, graphic), and any other peripheral controllers.

The NIC 660 provides network connectivity to the processing unit 230. The NIC 660 may generate interrupts as part of the processing of communication transactions. In one embodiment, the NIC 660 is compatible with both 32-bit and 64-bit peripheral component interconnect (PCI) bus standards. It is typically compliant with PCI local bus revision 2.2, PCI-X local bus revision 1.0, or PCI-Express standards. There may be more than one NIC 660 in the processing system. Typically, the NIC 660 supports standard Ethernet minimum and maximum frame sizes (64 to 6518 bytes), frame format, and Institute of Electronics and Electrical Engineers (IEEE) 802.2 Local Link Control (LLC) specifications. It may also support full-duplex Gigabit Ethernet interface, frame-based flow control, and other standards defining the physical layer and data link layer of wired Ethernet. It may support copper Gigabit Ethernet defined by IEEE 802.3ab or fiber-optic Gigabit Ethernet defined by IEEE 802.3z.

The NIC 660 may also be a host bus adapter (HBA) such as a Small Computer System Interface (SCSI) host adapter or a Fiber Channel (FC) host adapter. The SCSI host adapter may contain hardware and firmware on board to execute SCSI transactions or an adapter Basic Input/Output System (BIOS) to boot from a SCSI device or configure the SCSI host adapter. The FC host adapter may be used to interface to a Fiber Channel bus. It may operate at high speed (e.g., 2 Gbps) with auto speed negotiation with 1 Gbps Fiber Channel Storage Area Network (SANs). It may be supported by appropriate firmware or software to provide discovery, reporting, and management of local and remote HBAs with both in-band FC or out-of-band Internet Protocol (IP) support. It may have frame level multiplexing and out of order frame reassembly, on-board context cache for fabric support, and end-to-end data protection with hardware parity and cyclic redundancy code (CRC) support.

Elements of one embodiment of the invention may be implemented by hardware, firmware, software or any combination thereof. The term hardware generally refers to an element having a physical structure such as electronic, electromagnetic, optical, electro-optical, mechanical, electromechanical parts, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory, ROM, EPROM). Examples of firmware may include microcode, writable control store, micro-programmed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read only memory (ROM), a flash memory, an erasable programmable ROM (EPROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include information or data that, when accessed by a machine, cause the machine to perform the operations or actions described above. The machine accessible medium may also include program code embedded therein. The program code may include machine readable code to perform the operations or actions described above. The term “information” or “data” here refers to any type of information that is encoded for machine-readable purposes. Therefore, it may include program, code, data, file, etc.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
a supplementary display device (SDD) to display a high definition (HD) content being transmitted to a primary display device; and
an image sensor coupled to the SDD to capture the HD content displayed on the SDD.

2. The apparatus of claim 1 further comprising:
a processing unit coupled to the imaging sensor to process the captured HD content.

3. The apparatus of claim 2 wherein the processing unit comprises:
a compressor to compress the captured HD content to a compressed content according to a compression standard; and
a network interface circuit to transmit the compressed content to a network.

4. The apparatus of claim 2 wherein the processing unit comprises:
a controller to respond to copy protection information.

5. The apparatus of claim 3 wherein the processing unit further comprises:
a storage unit to store the captured HD content or the compressed content.

6. The apparatus of claim 3 wherein the compression standard is a Moving Picture Experts Group (MPEG) standard including MPEG-2 and advanced video coding (AVC).

7. The apparatus of claim 3 wherein the network is a home network including at least one of an Internet Protocol (IP) network, a wireless local area network (LAN), and a power line communication (PLC).

8. The apparatus of claim 1 wherein the image sensor is a charge coupled device (CCD) sensor or a complementary metal oxide semiconductor device (CMOS) sensor.

9. The apparatus of claim 1 wherein the SDD is a flat-panel display.

10. The apparatus of claim 1 wherein the SDD is one of a liquid crystal display (LCD) device, an electronic paper, an organic light-emitting-diode (OLED) device, and interferometric modulator display (IMOD) device.

11. The apparatus of claim 1 wherein the compressed content is copy protected.

12. The apparatus of claim 1 further comprising:
a fitting structure integrated or attached to one of the image sensor and the SDD to provide desired coupling between the image sensor and the SDD.

13. The apparatus of claim 1 further comprising:
a housing to enclose the SDD and the image to provide proper lighting condition for image capture.

14. An apparatus comprising:
a fitting structure integrated or attached to one of an image sensor and a supplementary display device (SDD) to provide desired coupling between the image sensor and the SDD, the SDD displaying a high definition (HD) content being transmitted to a primary display device, the image sensor capturing the HD content displayed on the SDD.

15. An apparatus comprising:
a supplementary display device (SDD) to display a high definition (HD) content being transmitted to a primary display device; and
a housing enclosing the SDD and an image sensor to prevent ambient light from striking surface of the SDD, the image sensor capturing the HD content displayed on the SDD.

16. A method comprising:
displaying a high definition (HD) content on a supplementary display device (SDD), the HD content being transmitted to a primary display device; and
capturing the HD content displayed on the SDD by an image sensor.

17. The method of claim 10 further comprising:
processing the captured HD content by a processing unit.

18. The method of claim 11 wherein processing the captured HD content comprises:
compressing the captured HD content to a compressed content according to a compression standard; and
transmitting the compressed content to a network.

19. The method of claim 12 wherein processing the captured HD content further comprises:
storing the captured HD content or the compressed content in a storage unit.

20. The method of claim 12 wherein the compression standard is a Moving Picture Experts Group (MPEG) standard including MPEG-2 and advanced video coding (AVC).

21. The method of claim 12 wherein the network is a home network including at least one of an Internet Protocol (IP) network, a wireless local area network (LAN), and a power line communication (PLC).

22. The method of claim 10 wherein the SDD is one of a liquid crystal display (LCD) device, an electronic paper, an organic light-emitting-diode (OLED) device, and interferometric modulator display (IMOD) device.

23. A system comprising:
a receiver to receive a high definition (HD) content from one of a satellite source, a cable source, and a over-the-air source;
a set-top box (STB) coupled to the receiver to transmit a stream containing the HD content to a primary display device; and
a visual capture unit coupled to the STB to visually capture the HD content, the visual capture unit comprising:
a supplementary display device (SDD) to display a high definition (HD) content being transmitted to a primary display device, and
an image sensor coupled to the SDD to capture the HD content displayed on the SDD.

24. The system of claim 23 wherein the visual capture unit further comprises:
a processing unit coupled to the imaging sensor to process the captured HD content.

25. The system of claim 24 wherein the processing unit comprises:
a compressor to compress the captured HD content to a compressed content according to a compression standard; and
a network interface circuit to transmit the compressed content to a network.
